(19) United States
(12) Patent Application Publication
(10) Pub. No.: US 2016/0304195 A1
(43) Pub. Date: Oct. 20, 2016

(54) MISSION FLEXIBLE, ENGINE FLEXIBLE, ASYMMETRIC VERTICAL TAKE-OFF AND LANDING (VTOL) AIRCRAFT

(71) Applicant: Sikorsky Aircraft Corporation, Stratford, CT (US)

(72) Inventors: Mark R. Alber, Milford, CT (US); Charles Gayagoy, Orange, CT (US); Jeffrey Parkhurst, Meriden, CT (US); Timothy Fred Lauder, Oxford, CT (US); Michael Joseph DeVita, Cos Cob, CT (US)

(21) Appl. No.: 15/042,315

(22) Filed: Feb. 12, 2016

Related U.S. Application Data
(60) Provisional application No. 62/148,489, filed on Apr. 16, 2015.

(51) Int. Cl. B64C 29/02; B64C 1/26; B23P 15/00; B64C 3/00

(52) U.S. Cl. CPC B64C 29/02; B64C 3/00; B64C 1/26; B23P 15/00; B23P 2700/01

(57) ABSTRACT

An aircraft is provided and includes a propeller to generate aircraft thrust, a prop-nacelle housing and supporting the propeller, a wing supporting the prop nacelle and including first coupling elements. The first coupling elements are each configured to selectively couple with a second set of coupling elements associated with a group of interchangeable fuselages.

### CROSS-REFERENCE TO RELATED APPLICATIONS

This application claims priority to U.S. Provisional Patent Application No. 62/148,489, filed on Apr. 16, 2015. The contents of which are incorporated herein by reference.

### STATEMENT OF FEDERALLY SPONSORED RESEARCH AND DEVELOPMENT

This invention was made with government support with the United States Government under Contract No. N00019-06-C-0081. The government therefore has certain rights in this invention.

### BACKGROUND OF THE INVENTION

The subject matter disclosed herein relates to a vertical take-off and landing (VTOL) aircraft and, more particularly, to a mission flexible, engine flexible, asymmetric VTOL aircraft.

Aircraft missions often require VTOL capability that is combined with long range and endurance and can be very demanding. Conventional configurations of such aircraft are designed primarily for efficient forward flight, for efficient vertical lift or a poor compromise solution that permits both forward and vertical flight. Alternatively, some configurations include tilt-wing or tilt-rotor features that allow tilting of the fuselage with respect to the nacelles and have VTOL capabilities, long range and endurance but pay a high penalty in terms of complexity, higher empty weight and other inefficiencies.

One particular configuration is a rotor blown wing (RBW) configuration where a hybrid aircraft can fly as a rotorcraft and as a fixed wing aircraft. In such cases, a single engine capability for the aircraft may be warranted based on mission requirements, engine availability and operational benefits of a single vs. a twin engine arrangement. Normally, however, the single engine would be located within the center fuselage section of the aircraft and thus would require a high weight center engine underslung configuration or a similarly heavy center engine coplanar configuration to transmit power to both engine nacelles. Moreover, the disposition of the single engine in the center fuselage would limit the type of center fuselage available for a given mission and possibly lead to a center fuselage being chosen for a given mission despite not being ideally suited for the same.

### BRIEF DESCRIPTION OF THE INVENTION

According to one aspect of the invention, an aircraft is provided and includes a propeller to generate aircraft thrust, a prop-nacelle housing and supporting the propeller, a wing supporting the prop nacelle and including first coupling elements. The first coupling elements are each configured to selectively couple with a second set of coupling elements associated with a group of interchangeable fuselages.

In accordance with additional or alternative embodiments, a selected one of the group of interchangeable fuselages is selected to support a given mission.

In accordance with additional or alternative embodiments, the group of interchangeable fuselages has a common arrangement of the second set of coupling elements.

In accordance with additional or alternative embodiments, the group of interchangeable fuselages includes fuselages with angular cross-sections, fuselages with annular cross-sections, fuselages with partially angular and annular cross-sections and station fuselages.

In accordance with additional or alternative embodiments, the group of interchangeable fuselages includes fuselages with hexagonal, elliptical and rectangular cross-sections in a plane parallel to that of the wing.

In accordance with additional or alternative embodiments, the interchangeable fuselages are underslung with respect to the wing, the first coupling elements are disposed on an underside of the wing and the second coupling elements are disposed on respective upper surfaces of the interchangeable fuselages.

In accordance with additional or alternative embodiments, the first coupling elements are disposed in sequence on the underside of the wing.

In accordance with additional or alternative embodiments, the interchangeable fuselages are insertible onto the wing and are formed to define an insertion bore into which the wing is finable.

In accordance with additional or alternative embodiments, locking elements lock the interchangeable fuselages onto the wing

According to another aspect of the invention, a method of assembling an aircraft is provided and includes designing a mission profile, forming a group of unique fuselages that are respectively configured to be coupled to a wing having prop-nacelles supported thereon to generate aircraft thrust, selecting one of the fuselages from the group of unique fuselages in accordance with the mission profile and coupling the selected one of the fuselages to the wing.

In accordance with additional or alternative embodiments, the group of unique fuselages includes fuselages with angular cross-sections, fuselages with annular cross-sections, fuselages with partially angular and annular cross-sections and station fuselages.

In accordance with additional or alternative embodiments, the group of unique fuselages includes fuselages with hexagonal, elliptical and rectangular cross-sections in a plane parallel to that of the wing.

In accordance with additional or alternative embodiments, the fuselages are configured to be underslung with respect to the wing or insertible onto the wing.

In accordance with additional or alternative embodiments, the coupling includes coupling each one of the fuselage to the wing via unique coupling elements.

In accordance with additional or alternative embodiments, the method further includes replacing the selected one of the fuselages with an alternative one of the fuselages for a second mission profile.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an elevation view of a vertical take-off and landing (VTOL) aircraft in a grounded condition in accordance with embodiments;

FIG. 2 is a perspective skeletal view of the VTOL aircraft of FIG. 1;

FIG. 3 is an elevation, skeletal view of the VTOL aircraft of FIG. 1 and an asymmetrical power generation unit thereof in accordance with embodiments;

FIG. 4 is a front view of the VTOL aircraft of FIGS. 1-3 illustrating alighting element configurations in accordance with embodiments;

FIG. 5 is a front view of the VTOL aircraft of FIGS. 1-3 illustrating alighting element configurations in accordance with alternative embodiments;

FIG. 6 is a top-down view of the asymmetrical power generation unit of the VTOL aircraft of FIGS. 1-3;

FIG. 7 is a perspective view of components of the asymmetrical power generation unit of FIG. 6;

FIGS. 8A-8G are axial views of a VTOL aircraft with various fuselages coupled to a single wing;

FIG. 9 is a plan view of an underside of the single wing of FIGS. 8A-8G;

FIG. 10 is a plan view of various cross-sectional shapes of various types of fuselages;

FIG. 11 is a side diagrammatic view of an insertion of a fuselage onto a single wing; and

FIG. 12 is a flow diagram illustrating a method of assembling an aircraft.

The detailed description explains embodiments of the invention, together with advantages and features, by way of example with reference to the drawings.

### DETAILED DESCRIPTION OF THE INVENTION

As will be described below, a hybrid aircraft is provided that can fly as a rotorcraft and as a fixed wing aircraft. To meet specific needs, the aircraft may have single or dual engine flexibility so that it can be adaptable for various mission profiles. Moreover, the fuselage architecture offers mission flexibility and further adaptability. That is, with the engine(s) located in nacelle(s), various types of fuselages can be selected for use on given missions to store payloads, mission equipment and fuel.

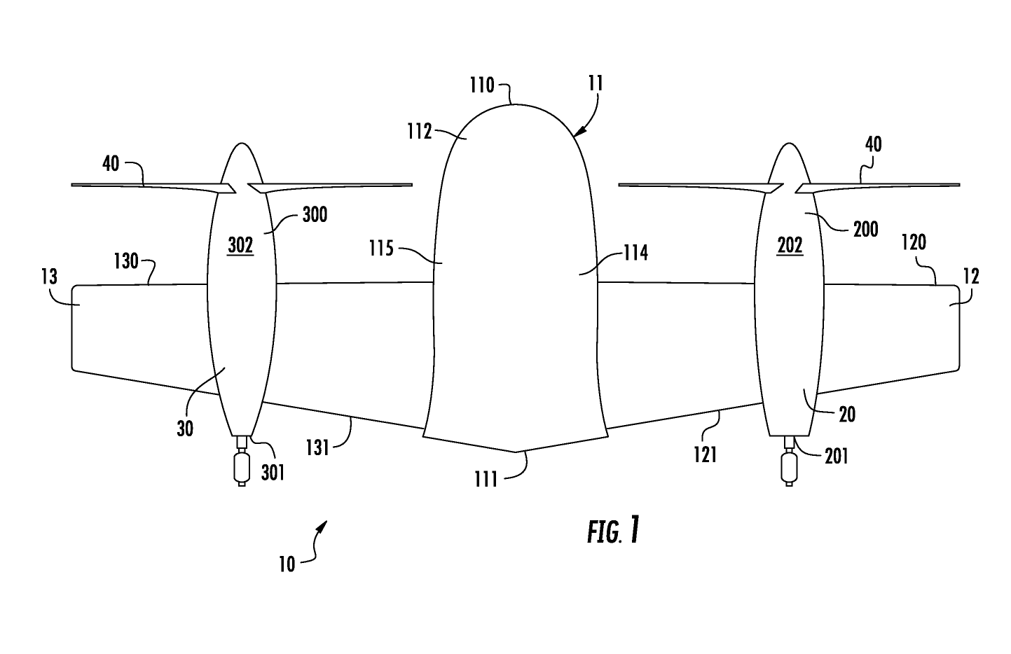

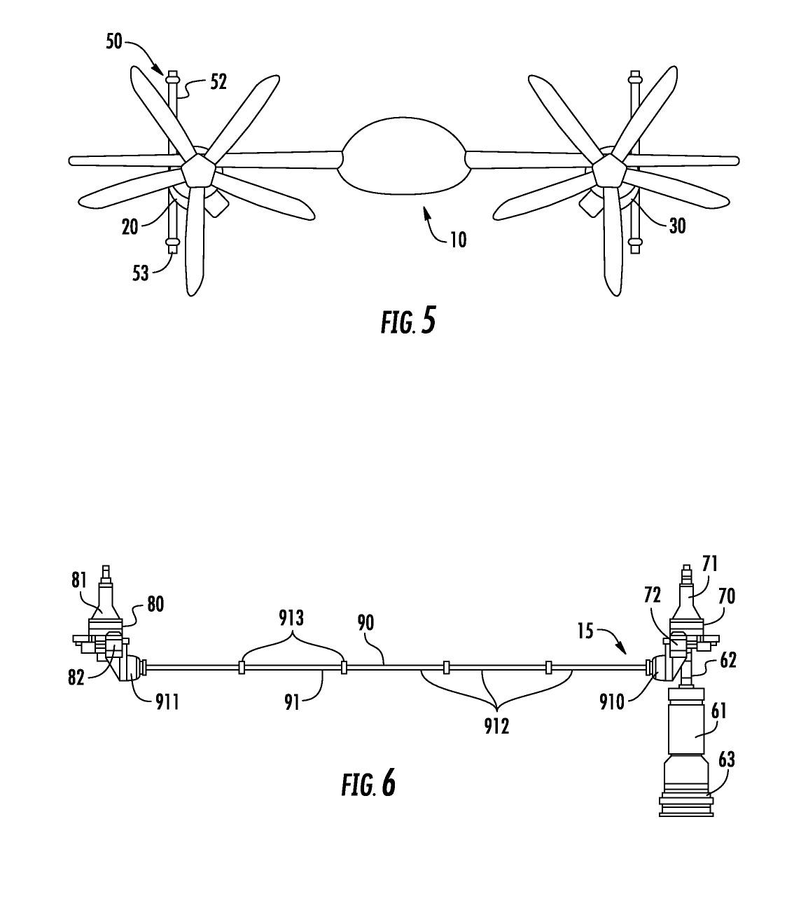

With reference to FIGS. 1-5, a rotor blown wing (RBW) vertical take-off and landing (VTOL) aircraft 10 is provided. The aircraft 10 includes a fuselage 11 that generally has an aerodynamic shape with a nose section 110, a trailing end 111 opposite from the nose section 110 and an airframe 112. The airframe 112 is generally smooth but may include sensor components protruding into or out of the airframe 112. The airframe 112 may or may not have a dorsal fin or horizontal or vertical stabilizer elements. The airframe 112 has first and second opposite sides 114 and 115 and is formed and sized to encompass at least one or more of aircraft electronic components, payload elements and fuel in accordance with mission requirements. Although the fuselage 11 is illustrated in FIG. 1 as having a blunted nose, it is to be understood that other shapes (e.g., delta-wing shapes) are possible as will be discussed below.

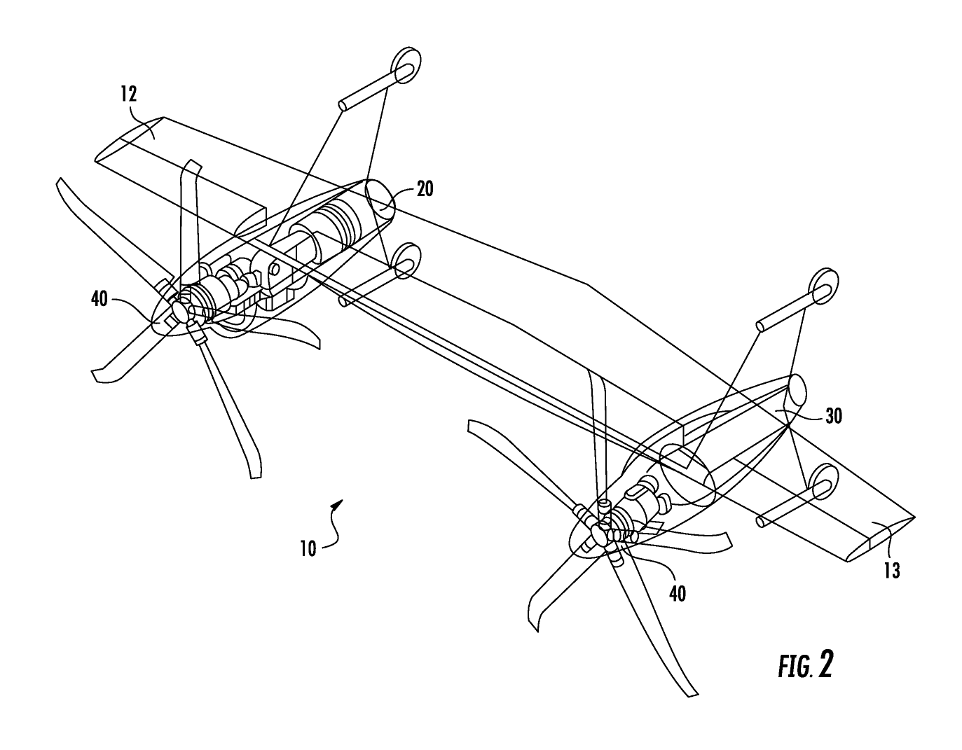

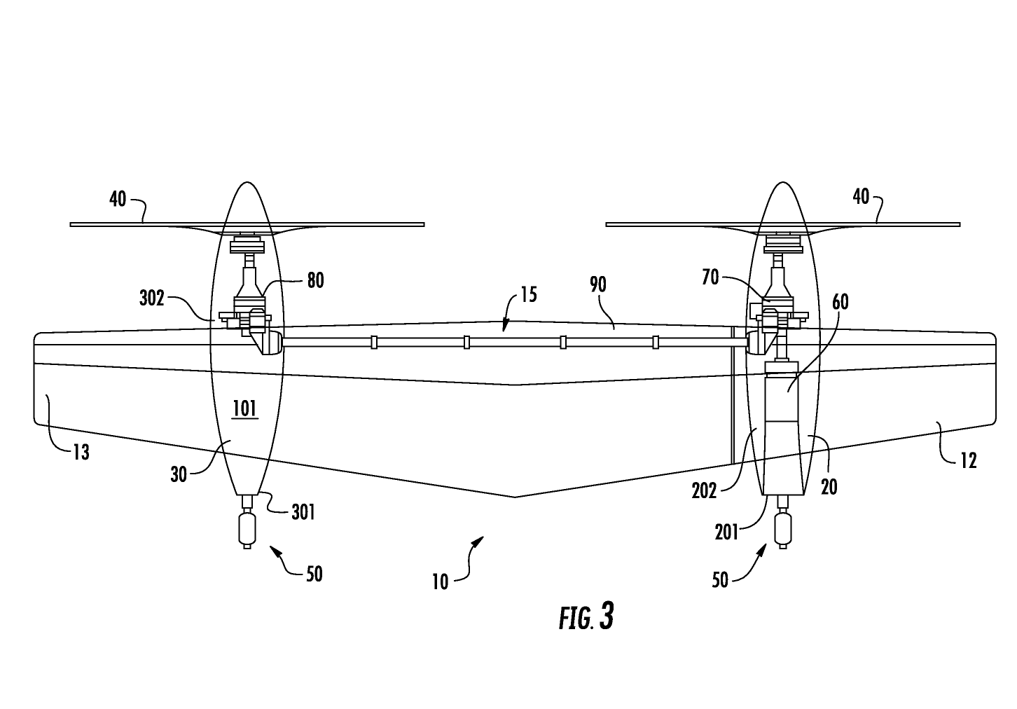

The aircraft 10 further includes first and second wings 12 and 13 that extend outwardly from the first and second opposite sides 114 and 115 of the airframe 112, respectively, a first nacelle 20 supported on the first wing 12, a second nacelle 30 supported on the second wing 13, a rigid rotor propeller 40 disposed on each of the first and second nacelles 20 and 30 and a flight computer. The first and second wings 12 and 13 may be joined directly to one another as shown in FIGS. 2 and 3.

The first and second wings 12 and 13 may also be foldable about hinges disposed along the first and second wings 12 and 13 proximate to the first and second nacelles 20 and 30 and are substantially similar in shape and size. In accordance with embodiments, the first and second wings 12 and 13 may be configured as high aspect ratio wings that have a span or longitudinal length that substantially exceeds a chord where the span or longitudinal length is measured from the first and second opposite sides 114 and 115 to distal tips of the first and second wings 12 and 13 and the chord is measured from the leading edges 120/130 to the trailing edges 121/131 of the first and second wings 12 and 13. In accordance with further embodiments, the leading edges 120/130 may be un-swept and the trailing edges 121/131 may be forwardly swept.

The first and second nacelles 20 and 30 are supported on each of the first and second wings 12 and 13 at about 40-60% span locations, respectively. The first and second nacelles 20 and 30 have an aerodynamic shape with forward sections 200, 300, trailing end portions 201, 301 opposite from the forward sections 200, 300 and nacelle frames 202, 302. The nacelle frame 202 is generally smooth and formed and sized to encompass an engine unit (e.g., a gas turbine engine or an electronic motor-generator) as will be described below. The nacelle frame 302 is also generally smooth and formed and sized to encompass aircraft electronic components, payload elements and/or fuel. It will be understood of course that this configuration can be reversed with the engine unit being encompassed within the nacelle frame 302 and the aircraft electronic components, payload elements and/or fuel encompassed within the nacelle frame 202 and that both nacelle frames 202 and 302 may encompass an engine unit in a dual engine configuration. For purposes of clarity and brevity, however, the following descriptions will relate to only case in which the nacelle frame 202 encompasses an engine unit and the nacelle frame 302 encompasses aircraft electronic components, payload elements and/or fuel.

The rigid rotor propellers 40 are disposed at the forward sections 200, 300 on each of the first and second nacelles 20 and 30. Each of the rigid rotor propellers 40 is drivable to rotate about only a single rotational axis, which is defined along and in parallel with a longitudinal axis of the corresponding one of the first and second nacelles 20 and 30. Power required for driving the rotations of the rigid rotor propellers 40 may be generated from the engine unit encompassed within the nacelle frame 202. Where this engine unit is located remotely from the rigid rotor propeller 40 of the second nacelle 30, the aircraft 10 may further include a laterally oriented drive shaft for transmission of power generated by the gas turbine engine or electronic couplings running laterally along the aircraft 10 for transmission of power generated by the electronic motor-generator. Such a transmission system will be described in greater detail below.

Each rigid rotor propeller 40 includes a hub and rotor blades that extend radially outwardly from the hub. As the rigid rotor propellers 40 are driven to rotate, the rotor blades rotate about the rotational axes and aerodynamically interact with the surrounding air to generate lift and thrust for the aircraft 10. The rotor blades are also controllable to pitch about respective pitch axes that run along their respective longitudinal lengths. Such rotor blade pitching can be commanded collectively or cyclically by at least the flight computer, which may be embodied in the aircraft electronic components of one or more of the fuselage 11 and the second nacelle 30. Collective pitching of the rotor blades increases or decreases an amount of lift and thrust the rigid rotor propellers 40 generate for a given amount of applied torque. Cyclic pitching of the rotor blades provides for navigational and flight control of the aircraft 10.

Each of the rigid rotor propellers 40 may be fully cyclically controllable by rotor controls (i.e., cyclic and collective functions using servo actuators, a swashplate and pitch change rod mechanisms) with signal inputs from a flight computer. This full cyclic control may be referred to as active proprotor control and permits the elimination of fixed wing controls (i.e., ailerons and elevons from the aircraft 10), which could lead to a further reduction in weight. In any case, the full cyclic control of the rigid rotor propellers 40 allows the aircraft 10 to take off and land vertically with the node section 110 pointed upwardly while permitting a transition to wing borne flight. Such transition is effected by simply pitching the cyclic control forward to thereby cause the entire aircraft 10 to rotate from a vertical orientation to a horizontal orientation.

In order to reduce a footprint of the aircraft 10, each of the rigid rotor propellers 40 may include a set of rotor blades of which one may be a non-foldable rotor blade or a foldable rotor blade to reduce space when the aircraft is not operating, two may be opposed once-foldable rotor blades and one may be a twice-foldable rotor blade that is disposed opposite the non-foldable rotor blade. When the aircraft 10 is grounded or not in flight, the first and second wings 12 and 13, the once-foldable rotor blades and the twice foldable rotor blades may each assume their respective folded conditions. By contrast, when the aircraft 10 is prepped for flight conditions, the first and second wings 12 and 13, the once-foldable rotor blades and the twice foldable rotor blades may each assume their respective unfolded conditions.

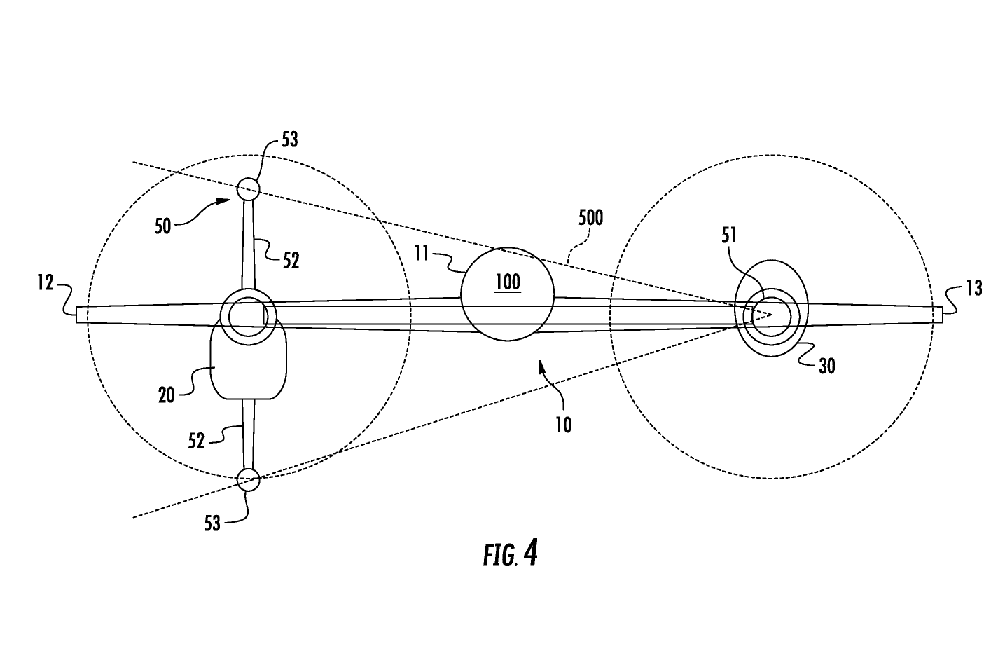

In addition to the features described above and, with reference to FIGS. 3-5, the aircraft 10 may include alighting elements 50 coupled to the trailing end portions 201, 301 of each of the first and second nacelles 20 and 30. In accordance with embodiments, the alighting elements 50 may form at least a three-point or four-point, stable support system 500 (see the dotted lines of FIG. 4) that supports in the aircraft 10 against rolling over in any given direction. In this case, the second nacelle 30 has a single alighting element 51 disposed in line with its longitudinal axis. By contrast, the first nacelle 20 includes spires 52 extending away from a plane of the first wing 12 and dual alighting elements 53 at distal ends of the spires 52. The spires 52 allow for a positioning of the dual alighting elements 53 away from exhaust from the engine unit disposed in the first nacelle 20. The three-point stable support system 500 is thus provided by the combination of the single alighting element 51 and the dual alighting elements 53.

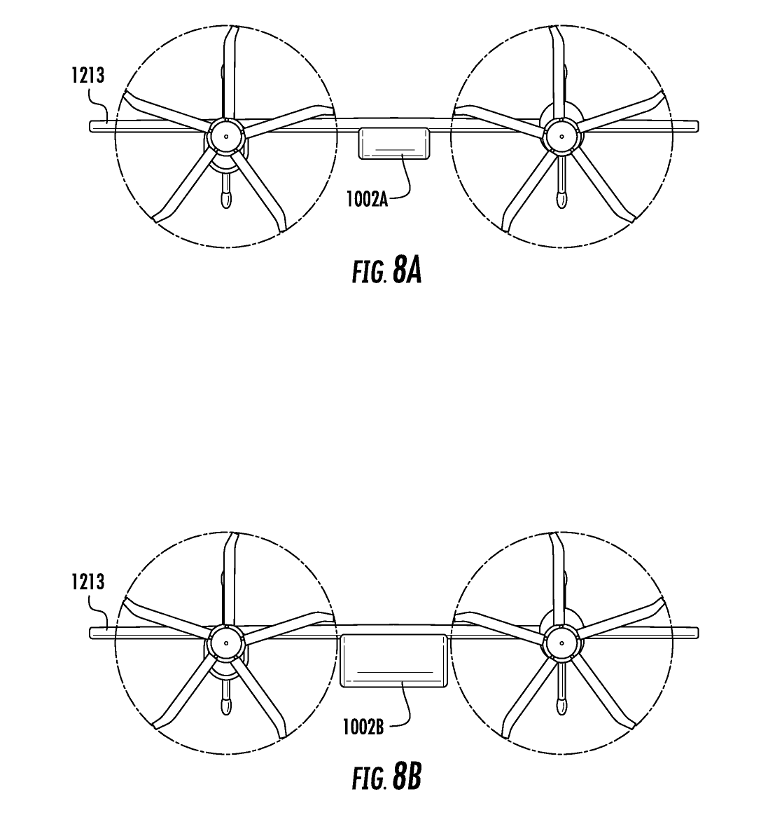

With reference to FIGS. 3, 6 and 7, the aircraft 10 may include an asymmetrical power generation unit 15. The asymmetrical power generation unit 15 includes a single engine unit 60 disposed in only one of the first and second nacelles 20 and 30 (i.e., within the nacelle frame 202 of the first nacelle 20) to generate power to drive the propellers 40 of both the first and second nacelles 20 and 30. In addition, the aircraft includes a first gearbox assembly 70, a second gearbox assembly 80 and a drive shaft assembly 90. In accordance with embodiments, while conventional VTOL aircraft with symmetric engine nacelle configurations may have relatively heavy engine components, the asymmetrical power generation unit 15 has a substantially reduced weight.

The single engine unit 60 is configured to generate power to be used to drive rotations of the propellers 40 and thus may be provided as a gas turbine engine 600 or an electric motor-generator. In the former case, where the single engine unit 60 is provided as the gas turbine engine, the drive shaft assembly 90 is provided as a drive shaft unit 91 that transmits rotational energy from the first nacelle 20 to the second nacelle 30. In the latter case, where the single engine unit 60 is provided as the electrical motor-generator, the drive shaft assembly 90 may be provided as electrical couplings that are disposed to transmit electrical power from the first nacelle 20 to the second nacelle 30. While each case is encompassed by this disclosure, for purposes of clarity and brevity, only the case of the single engine unit 60 being a gas turbine engine and the drive shaft assembly 90 being a drive shaft unit 91 will be described in detail further.

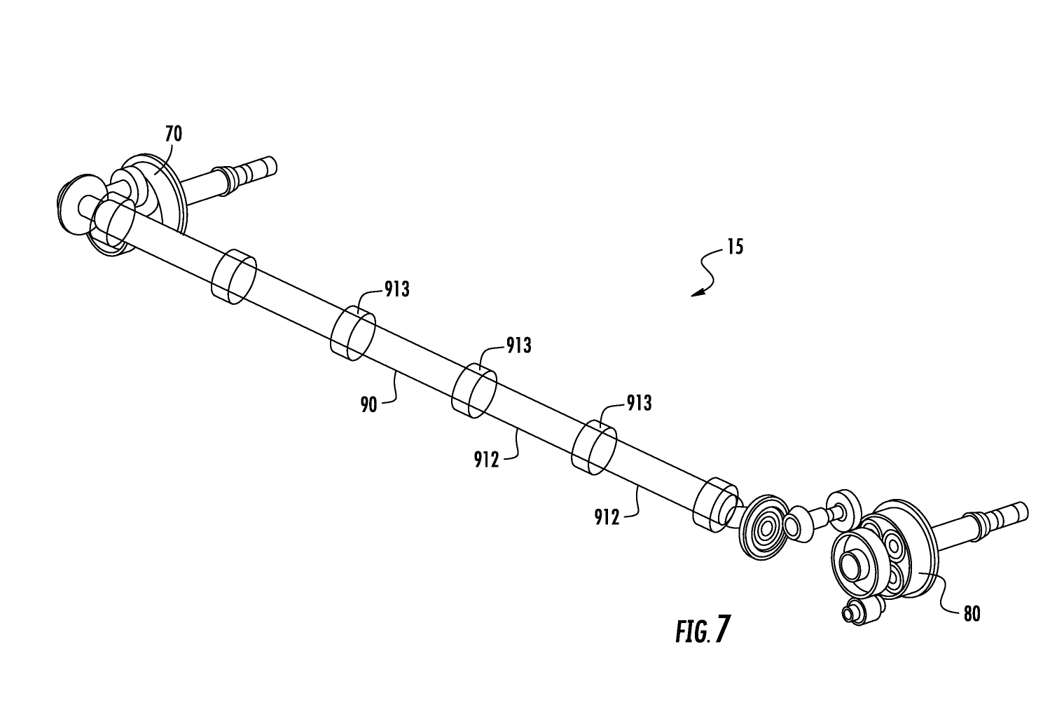

In accordance with embodiments and, as shown in FIG. 6, the single engine unit 60 includes a compressor-combustor-turbine (CCT) section 61, an output shaft 62 and an exhaust duct 63. The CCT section 61 is configured to compress inlet air, to mix the compressed air with fuel, to combust the mixture to produce high energy fluids and to expand the high energy fluids to generate rotational energy. This rotational energy is then transmitted to the output shaft 62 to cause the output shaft 62 to rotate about its longitudinal axis as the remaining high energy fluids are exhausted from the nacelle frame 202 through the exhaust duct 63.

Although the embodiments of FIG. 6 relate to a gas turbine or turbo-shaft engine, it is to be understood that these embodiments are merely exemplary and that other configurations and engine types are possible. As examples, the other engine types may include, but are not limited to, rotary engines, internal combustion engines, electrical motor-generator engines and hybrid engines.

The output shaft 62 is coupled to the first gearbox assembly 70 such that the rotation of the output shaft 62 is transmitted to the first gearbox assembly 70, which is disposed to then drive rotations of the propeller 40 of the first nacelle 20. The first gearbox 70 may be provided as a 90 degree, multi-stage, multi-attitude gearbox and may include a gear train section 71 and a 90 degree power/torque splitting section 72. The gear train section 71 may be configured to gear up or down the rotations of the output shaft 62 such that the propeller 40 rotates at an appropriate speed and can be coupled to the flight computer such that the flight computer can control the gearing up or down. The 90 degree power/torque splitting section 72 is coupled to the drive shaft unit 91 such that rotation of the output shaft 62 transmitted to the first gearbox assembly 70 can also be transmitted to the drive shaft unit 91.

The drive shaft unit 91 is coupled to the second gearbox assembly 80 such that the rotation of the drive shaft unit 91 is transmitted to the second gearbox assembly 80, which is disposed to then drive rotations of the propeller 40 of the second nacelle 30. The second gearbox 80 may be provided as a 90 degree, multi-stage, multi-attitude gearbox and may include a gear train section 81 and a 90 degree power/torque receiving section 82. The gear train section 81 may be configured to gear up or down the rotations of the drive shaft unit 91 such that the propeller 40 rotates at an appropriate speed and can be coupled to the flight computer such that the flight computer can control the gearing up or down. The 90 degree power/torque receiving section 82 is coupled to the drive shaft unit 91 such that rotation of the drive shaft unit 91 can be transmitted to the second gearbox assembly 80.

The drive shaft unit 91 extends through the fuselage 11 and through the inward portions of the first and second wings 12 and 13 and may be provided as a plurality of shaft sections that are coupled together as a unit. The drive shaft unit 91 includes a first coupling unit 910 at a first end thereof, a second coupling unit 911 at a second end thereof, a series of shaft sections 912 provided in an end-to-end connected configuration between the first and second coupling units 910 and 911 and a series of bearings 913. The first coupling unit 910 is coupled to an end-most one of the shaft sections 912 and to the 90 degree power/torque splitting section 72 of the first gearbox assembly 70. The second coupling unit 911 is coupled to the other end-most one of the shaft sections 912 and to the 90 degree power/torque receiving section 82 of the second gearbox assembly 80. The bearings 913 may be provided as rotor bearings and are supportively disposed within the fuselage 11 and the first and second wings 12 and 13 to rotatably support the drive shaft unit 91.

In accordance with embodiments and, as shown in FIG. 4, the fuselage 11 may be formed to define an interior space 100 while, as shown in FIG. 3, the second nacelle 30 may be formed to define an interior nacelle space 101. In each case, the interior space 100 and the interior nacelle space 101 are sized to fit the above noted aircraft electronic components, payload elements and fuel in accordance with design considerations. In particular, the interior space 100 is sized to fit the aircraft electronic components, payload elements and fuel around the drive shaft unit 91 while the interior nacelle space 101 is sized to fit the aircraft electronic components, payload elements and fuel around the second gearbox assembly 80.

In accordance with further embodiments, the interior space 100 and the interior nacelle space 101 may be disposed to have fit therein fixed equipment like avionics, aircraft systems, auxiliary power units (APUs), fixed mission equipment, etc. The weight of such equipment may be used particularly in the interior nacelle space 101 to compensate for the weight of the single engine unit 70 in the first nacelle 20. In some cases, the weight compensation is such that the center of gravity (CG) of the aircraft 10 is located along or substantially close to a geometric centerline of the aircraft 10. To an extent that the CG is not located along or substantially close to the geometric centerline, the asymmetrical power generation unit 15 may be controlled variably at the first and second nacelles 20 and 30.

Moreover, to an extent that the weight of the equipment housed in the interior space 100 and the interior nacelle space 101 changes over time (i.e., due to expendables such as used fuel or equipment being discarded from the aircraft 10), the CG may correspondingly move relative to the geometric centerline during the course of a given mission. While expendables will normally be located at or near to the geometric centerline to minimize CG change when the aircraft 10 is loaded, offloaded or when expendables are released, it is possible that the CG may be initially set along or substantially close to the geometric centerline to later move away from this position or vice versa. In either case, ballast could be used or the asymmetrical power generation unit 15 may be controlled variably at the first and second nacelles 20 and 30 in order to compensate for in-mission movement of the CG. Furthermore, an acceptable displacement range of the CG relative to the geometric centerline can be pre-defined with an initial plan for housing equipment in the interior space 100 and the interior nacelle space 101 adjusted to insure that the CG does not exceed the displacement range during the given mission.

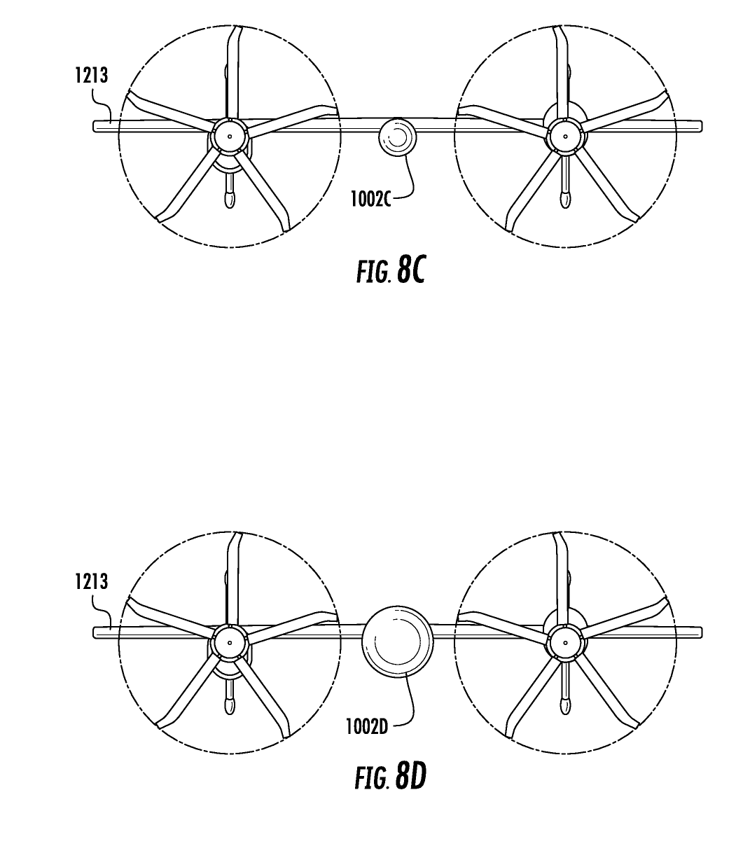

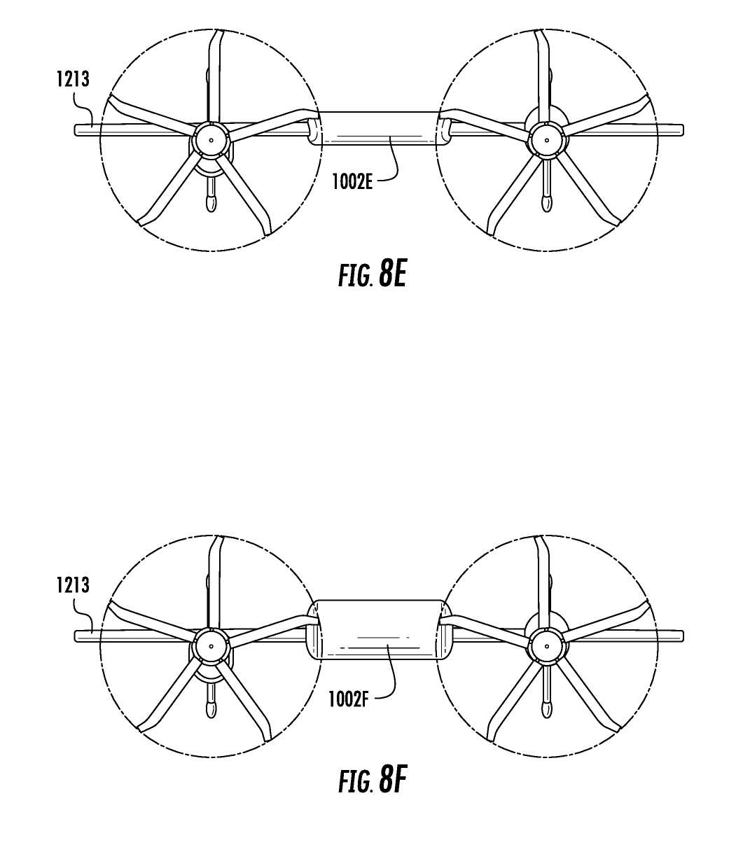

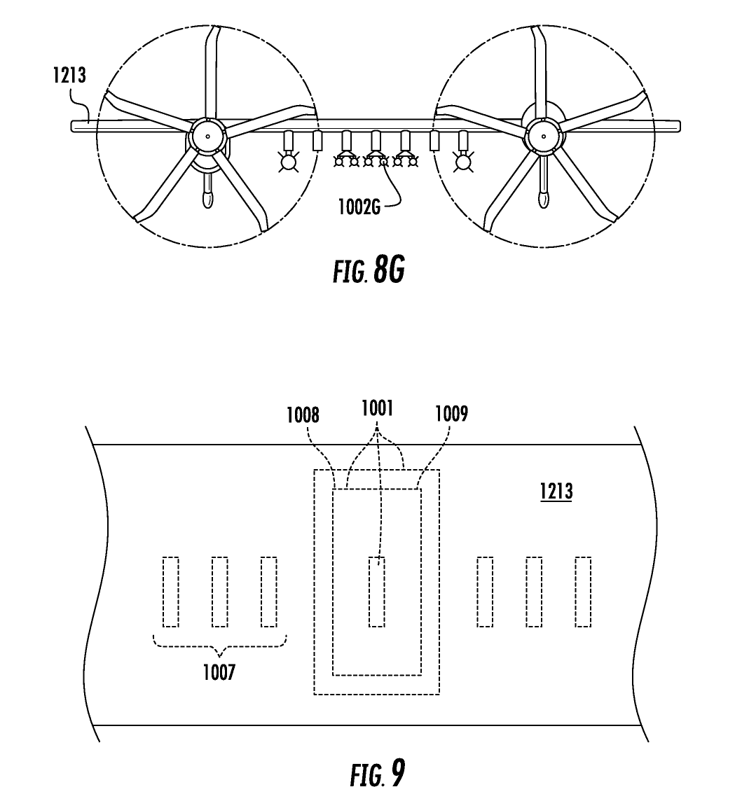

In accordance with further embodiments and, with reference to FIGS. 8A-8G, 9 and 10, the first and second wings 12 and 13 may be joined directly to one another to form a single wing 1213. This single wing 1213 includes first coupling elements 1001 (see FIG. 9) and, as noted above, has first and second nacelles 20 and 30 supported thereon with propellers 40 to generate aircraft thrust in a rotor blown wing (RBW) configuration. In order to complete an assembly of the aircraft 10, a group of fuselages 1002A-1002G are provided as shown in FIGS. 8A-8G and configured to be selectively coupled to the single wing 1213. Each of the fuselages 1002A-1002G has a unique shape and includes a second coupling element 1003 (see FIG. 10) that corresponds to an associated one of the first coupling elements 1001 to facilitate the coupling of the corresponding one of the group of fuselages 1002A-1002G with the single wing 1213 for a given mission.

As shown in FIGS. 8A-8G, the group of fuselages 1002A-1002G includes fuselages 1002A and 1002B with angular axial cross-sections, fuselages 1002C and 1002D with annular axial cross-sections, fuselages 1002E and 1002F with partially angular and annular axial cross-sections and station fuselages 1002G. In addition, as shown in FIG. 10, the group of fuselages 1002A-1002G includes fuselages with polygonal or hexagonal cross-sections 1004, elliptical cross-sections 1005 and rectangular cross-sections 1006 in a plane parallel to that of the single wing 1213. It is to be understood that any one or more of the fuselages 1002A-1002G can be configured with one or more of the polygonal or hexagonal cross-sections 1004, the elliptical cross-sections 1005 and the rectangular cross-sections 1006 and that the sizes of the fuselages 1002A-1002G can vary irrespective of whether they have the polygonal or hexagonal cross-sections 1004, the elliptical cross-sections 1005 and the rectangular cross-sections 1006.

At least the fuselages 1002A and 1002B and the station fuselages 1002G may be underslung with respect to the single wing 1213. In this case, the first coupling elements 1001 are disposed in one or more given sequences on an underside of the single wing 1213 and the second coupling elements 1003 are disposed on respective upper surfaces of the corresponding ones of the fuselages 1002A, 1002B and 1002G. In accordance with embodiments, the first coupling elements 1001 may be cooperative with any and all of the second coupling elements 1003 so that either of the fuselages 1002A and 1002B can be coupled to the first coupling elements 1001. In accordance with further embodiments, the first coupling elements 1001 may be disposed in an array 1007 to be cooperative with the second coupling elements 1003 of the station fuselages 1002G.

Alternatively, the sequence of the first coupling elements 1001 may be defined such that the first coupling elements 1001 for the fuselage 1002A are arranged in a first arrangement 1008 and the first coupling elements 1001 for the fuselage 1002B are arranged in a second arrangement 1009 surrounding the first arrangement 1005. Thus, with the second arrangement 1009 having a larger area than the first arrangement 1008, the first coupling elements 1001 for the fuselage 1002B would have a similarly large area as compared to the first coupling elements 1001 for the fuselage 1002A. As such, the first coupling elements 1001 for the fuselage 1002A can only form a coupling with the second coupling elements 1001 in the first arrangement 1008 and cannot form a coupling with the second coupling elements 1003 in the second arrangement 1009. Similarly, the first coupling elements 1001 for the fuselage 1002B can only form a coupling with the second coupling elements 1001 in the second arrangement 1009 and cannot form a coupling with the second coupling elements 1003 in the first arrangement 1008.

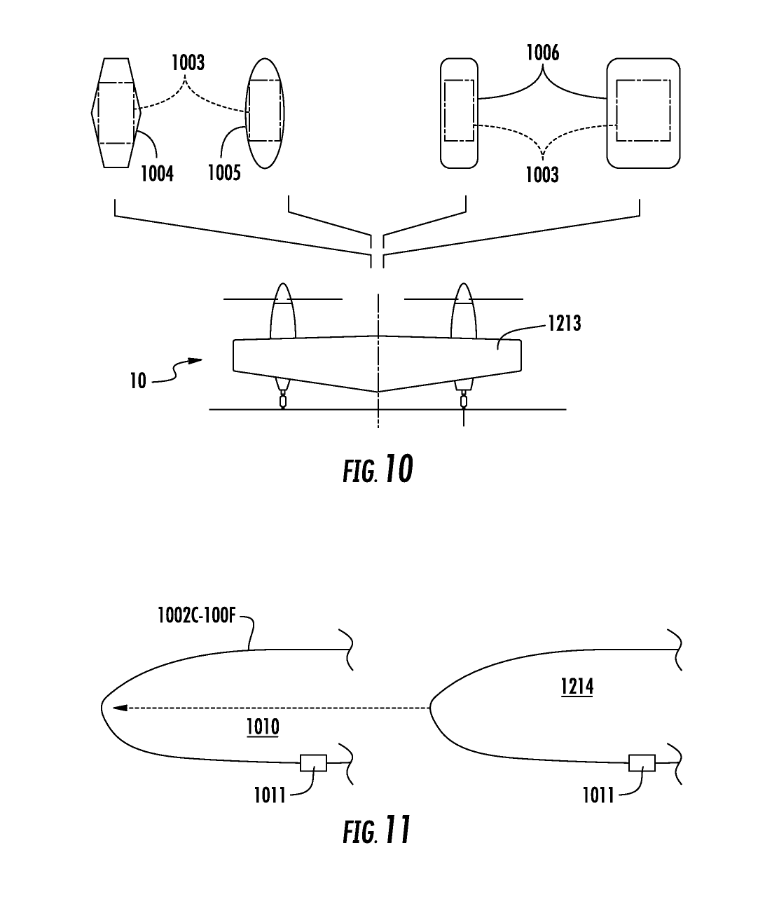

With reference to FIG. 11, at least the fuselages 1002C-1002F may be insertible onto the single wing 1213. In this case, the fuselages 1002C-1002F are formed to define an insertion bore 1010 into which the single wing 1213 is fittable and the aircraft 10 may further include locking elements 1011 disposed on either the single wing 1213 or the fuselages 1002C-1002F to lock the fuselages 1002C-1002F onto the single wing 1213.

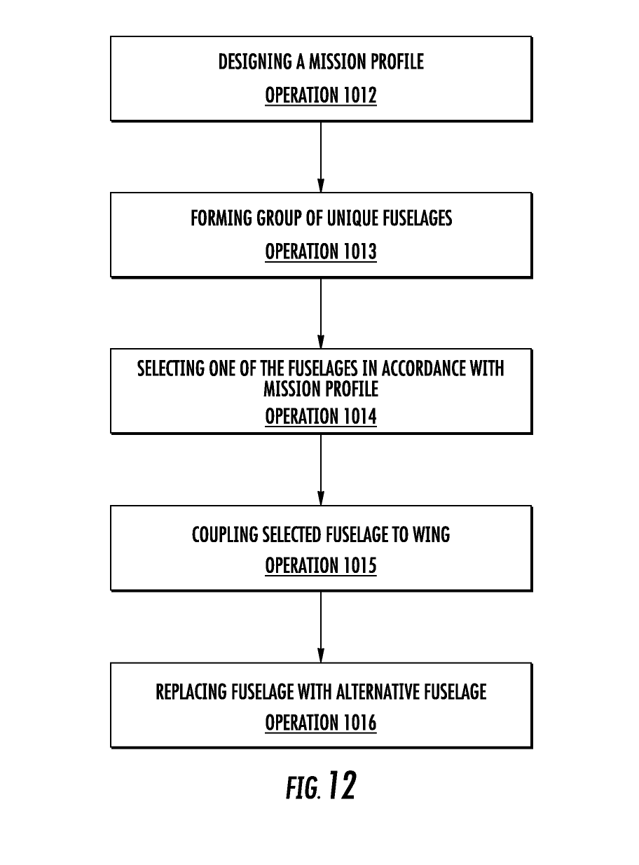

With the various fuselage 1002A-1002G available for use and, in accordance with further embodiments, a method of assembling the aircraft 10 is provided. With reference to FIG. 12, the method includes designing a mission profile (operation 1012), that are respectively configured to be coupled to a wing having prop-nacelles supported thereon to generate aircraft thrust (operation 1013), selecting one of the fuselages from the group of unique fuselages in accordance with the mission profile (operation 1014) and coupling the selected one of the fuselages to the wing (operation 1015). The method may further includes replacing the selected one of the fuselages with an alternative one of the fuselages for a second mission profile (operation 1016).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An aircraft, comprising:
a propeller to generate aircraft thrust;
a prop-nacelle housing and supporting the propeller;
a wing supporting the prop nacelle and including first coupling elements, the first coupling elements each being configured to selectively couple with a second set of coupling elements associated with a group of interchangeable fuselages.

2. The aircraft according to claim 1, wherein a selected one of the group of interchangeable fuselages is selected to support a given mission.

3. The aircraft according to claim 2, wherein the group of interchangeable fuselages has a common arrangement of the second set of coupling elements.

4. The aircraft according to claim 2, wherein the group of interchangeable fuselages comprises fuselages with angular cross-sections, fuselages with annular cross-sections, fuselages with partially angular and annular cross-sections and station fuselages.

5. The aircraft according to claim 2, wherein the group of interchangeable fuselages comprises fuselages with hexagonal, elliptical and rectangular cross-sections in a plane parallel to that of the wing.

6. The aircraft according to claim 1, wherein the interchangeable fuselages are underslung with respect to the wing, the first coupling elements are disposed on an underside of the wing and the second coupling elements are disposed on respective upper surfaces of the interchangeable fuselages.

7. The aircraft according to claim 6, wherein the first coupling elements are disposed in sequence on the underside of the wing.

8. The aircraft according to claim 1, wherein the interchangeable fuselages are insertible onto the wing and are formed to define an insertion bore into which the wing is finable.

9. The aircraft according to claim 8, further comprising locking elements to lock the interchangeable fuselages onto the wing.

10. A method of assembling an aircraft, the method comprising:
designing a mission profile;
forming a group of unique fuselages that are respectively configured to be coupled to a wing having prop-nacelles supported thereon to generate aircraft thrust;
selecting one of the fuselages from the group of unique fuselages in accordance with the mission profile; and
coupling the selected one of the fuselages to the wing.

11. The method according to claim 10, wherein the group of unique fuselages comprises fuselages with angular cross-sections, fuselages with annular cross-sections, fuselages with partially angular and annular cross-sections and station fuselages.

12. The method according to claim 10, wherein the group of unique fuselages comprises fuselages with hexagonal, elliptical and rectangular cross-sections in a plane parallel to that of the wing.

13. The method according to claim 10, wherein the fuselages are configured to be underslung with respect to the wing or insertible onto the wing.

14. The method according to claim 10, wherein the coupling comprises coupling each one of the fuselage to the wing via unique coupling elements.

15. The method according to claim 10, further comprising replacing the selected one of the fuselages with an alternative one of the fuselages for a second mission profile.
